(19) United States
(12) Patent Application Publication
(10) Pub. No.: US 2009/0311077 A1
(43) Pub. Date: Dec. 17, 2009

(54) NOTCH FORMING DEVICE, BOOKBINDING APPARATUS AND BOOKBINDING SYSTEM

(75) Inventor: Norishige KATO, Hachioji-shi (JP)

Correspondence Address: BUCHANAN, INGERSOLL & ROONEY PC, POST OFFICE BOX 1404, ALEXANDRIA, VA, 22313-1404, US

(73) Assignee: Konica Minolta Business Technologies, Inc., Chiyoda-ku (JP)

(21) Appl. No.: 12/479,886

(22) Filed: Jun. 8, 2009

(30) Foreign Application Priority Data
Jun. 12, 2008 (JP) 2008-154039

(51) Int. Cl. B42C 5/04; B65H 39/00; B42C 9/00; B42C 99/00

(52) U.S. Cl. 412/13; 270/58.07; 412/9; 412/37; 412/33; 270/52.02

(57) ABSTRACT

Notch grooves are formed on the edge of sheets in a sheet bundle. There are a plurality of patterns of the notch grooves. A pattern of the notch grooves different according to the settings of the job executed in the bookbinding apparatus is formed on the edge of the sheet bundle.

This application is based on Japanese Patent Application No. 2008-154039 filed on Jun. 12, 2008 in Japanese Patent Office, the entire content of which is hereby incorporated by reference.

### BACKGROUND OF THE INVENTION

The present invention relates to a notch forming device for forming a notch on the edge of the sheet constituting a sheet bundle outputted by execution of a job, and a bookbinding apparatus and bookbinding system for producing a booklet by forming a sheet bundle by stacking the sheets with notches formed thereon and by gluing the sheet bundle with adhesive.

Various forms of techniques have been proposed to produce a booklet using the method wherein a plurality of sheets with an image formed thereon are bundled to form a sheet bundle, and the sheet bundle and a cover sheet are glued by adhesive. An example of a proposed technique is a bookbinding system equipped with an image forming apparatus such as a photocopier and printer. In this system, a plurality of the sheets with an image formed thereon by an image forming apparatus are automatically bundled to form a sheet bundle. This sheet bundle is glued to a cover sheet using adhesive, whereby a booklet is produced.

The following describes the general procedure of binding a booklet using this bookbinding system. A plurality of sheets with an image formed thereon are stacked and aligned to form a sheet bundle. Then the spine of the stacked and aligned sheet bundle is coated with adhesive. Then the cover sheet is conveyed and stopped at a predetermined position, whereby the cover sheet is glued to the spine of the sheet bundle. This procedure allows a plurality of sheets and a cover sheet to be integrated into one body, whereby a booklet is bound.

Each of FIGS. 19a-19c shows an example of the booklet made up of a sheet bundle and cover sheet.

FIG. 19a shows that the cover sheet K is not folded, and FIG. 19b shows that the cover sheet K is folded. As shown in FIG. 19a, the sheet bundle Sa with adhesive coated on the spine Sb is moved in the direction of the arrow, and is glued to the cover sheet K. The sheet bundle Sa is covered with the cover sheet K in the form of capital U. In the final form of a booklet, the side edge Se of the sheet bundle Sa is aligned with the side edge Ke of the cover sheet K, as shown in FIG. 19b.

Incidentally, when adhesive is coated directly on the spine Sb of the sheet bundle Sa so that the sheet bundle Sa is glued to the cover sheet K, sufficient adhesive strength between the sheet bundle Sa and cover sheet K cannot be maintained, with the result that some of the sheets S fall out of the bound booklet. Such a problem occurs in some cases.

In one of the methods to solve this problem, notches V are formed on the edge of the sheet S corresponding to the spine Sb of the sheet bundle Sa, as shown in FIG. 20, and a space is maintained between the spine Sb of the sheet bundle Sa and the cover sheet so that a large amount of adhesive can enter that space, whereby adhesive strength is maintained between the sheet bundle Sa and cover sheet. In the technique disclosed in the Unexamined Japanese Patent Application Publication No. 2001-261221, a notch-forming device is provided on the conveyance path of the sheets with an image formed thereon, and notches V shown in FIG. 20 are automatically formed on the edge of the sheet S.

Each of FIGS. 21a-21c is an explanatory diagram representing the notch grooves Va formed on the spine Sb of the sheet bundle Sa. It shows the state of the spine Sb in the sheet bundle Sa as viewed from the X direction of FIG. 20.

Notches V are formed on the edge of the sheet S. When the sheets S are bundled into a sheet bundle Sa, the notch grooves Va of FIGS. 21a and 21b are formed.

Various forms of patterns can be designed for the notch grooves Va formed on the sheet bundle Sa. For example, as shown in FIG. 21a, they are exemplified by the pattern wherein a plurality of notch grooves Va are formed straight in the transverse direction, or the pattern wherein a plurality of notch grooves Va are formed in a slanting direction, as shown in FIG. 21b. In the pattern wherein a plurality of notch grooves Va of FIG. 21b are formed in a slanting direction, the positions of the notches V are misaligned between sheets in the lateral direction as shown in FIG. 21c. Accordingly, adhesive is attached to the hatched area of FIG. 21c, and sufficient adhesive strength between sheets can be maintained.

Further, the pattern of each notch groove has different characteristics. For example, as shown in FIG. 21a, the pattern of a plurality of notch grooves Va being formed straight in the transverse direction is characterized by effective protection against the so-called “spine split”, wherein the spine Sb of the sheet bundle Sa is broken and split (the area indicated by “z” in FIG. 22) when the booklet Bk is opened wide. However, the positions of the notches V are not misaligned among sheets in the lateral direction. Thus, the adhesive strength among sheets is not sufficiently maintained. This is not sufficient to protect against the accidental falling out of some sheets from the bound booklet.

As shown in FIG. 21b, if the pattern of a plurality of notch grooves Va are formed in a slanting direction, the position of the notch V is misaligned in the lateral direction among sheets as described with respect to FIG. 21c. This ensures sufficient adhesive strength to be maintained among sheets, and is very effective in protecting against the accidental falling out of some sheets from the produced booklet. However, this pattern fails to provide effective protection against the spine split shown in FIG. 22.

As described above, the characteristics of the booklet differs according to the pattern of the notch grooves Va. Different users have different requirements. For example, some require protection against removal of the sheets from a booklet, and others want to avoid the spine split. Further, to bind an adequate booklet, it is preferred that the notch grooves Va of an adequate pattern should be automatically selected in conformance to the type of the sheets S or the number of the sheets in the sheet bundles Sa.

However, the pattern of the notch grooves Va are fixed to one type, for example, and one pattern of the notch grooves Va is used to bind all booklets. Alternatively, the adhesive strength of the booklet fails to meet the requirements. Because of these problems, an appropriate booklet cannot be produced easily in conformance to the user's demands.

### SUMMARY

An aspect of a notch forming device of the present invention is as follows.

A notch forming device including,

a notch forming section for forming a notch on the edge of the sheets constituting a sheet bundle to be outputted by execution of a job,

a moving section for changing the position of the notch on the sheets formed by the notch forming section, and

a control section for controlling at least the moving section to ensure that the notch groove constituted by the notch is formed on an edge of the sheet bundle,

wherein the aforementioned control section controls at least the moving section for the purpose of forming the notch groove of a pattern that is different according to setting content of the job to be executed, on the edge of the sheet bundle.

A bookbinding apparatus relating to the present invention includes,

the aforementioned notch forming device, and a bookbinding section for producing a booklet by forming a sheet bundle by stacking the sheets on which a notch is formed by the notch forming device and by gluing a side of the edges of the sheets having the notch formed thereon, using adhesive.

A bookbinding system relating to the present invention includes,

an image forming apparatus which is provided with an operation section through which the aforementioned setting content is inputted, and which forms an image on sheets, and

the aforementioned bookbinding apparatus for binding a booklet using the sheets on which an image is formed by the image forming apparatus.

### BRIEF DESCRIPTION OF THE DRAWINGS

FIG. 1 is an overall schematic view representing a bookbinding system provided with an image forming apparatus, bookbinding apparatus, booklet storage apparatus, and automatic document feeder.

FIG. 2 is a block diagram representing a control system of the bookbinding system.

FIG. 3 is a cross sectional view showing the central portion of the bookbinding apparatus.

FIG. 4 is a cross sectional view showing that the sheet stacking section of the sheet bundle storage section is inclined.

FIG. 5 is a cross sectional view showing that the sheet stacking section of the sheet bundle storage section is in the upright position.

FIG. 6 is a cross sectional view showing a sheet bundle storage section, coating section, cover sheet supply section, trimming section, and booklet formation section.

FIG. 7 is a perspective view representing the periphery of the coating section.

Each of FIGS. 8a, 8b, 8c and 8d is a cross sectional view showing the booklet formation section and sheet bundle wherein the cover sheet folding process is illustrated.

Each of FIGS. 9a, 9b and 9c is a perspective view representing the booklet binding process using the sheet bundle and cover sheet.

FIG. 10 is a cross sectional view of a notching section.

Each of FIGS. 11a, 11b, 11c and 11d is a plane view showing the sheet containing notches and perforations formed thereon.

FIG. 12 is a front view of a notching section and moving section.

FIGS. 13a, 13b and 13c are a perspective view, front view, and partially enlarged view representing the sheet bundle consisting of the sheets containing notches.

Each of FIGS. 14a, 14b, 14c and 14d is an explanatory diagram showing the pattern of the notch grooves formed on the sheet bundle.

FIG. 15 is an explanatory diagram showing the patterns of the notch grooves which are displayed on the operation panel for selection by a user.

FIG. 16 is a flow chart showing the procedure of forming notches according to the pattern of the notch grooves.

FIGS. 17a and 17b are explanatory diagrams showing the other patterns of the notch grooves formed on the sheet bundle.

Each of FIGS. 18a, 18b and 18c is an explanatory diagram showing the setting screen of the operation section for inputting the pattern of the notch grooves.

Each of FIGS. 19a and 19b is a perspective view showing the booklet made up of a sheet bundle and a cover sheet.

FIG. 20 is a perspective view showing the sheet bundle wherein notches are formed.

Each of FIGS. 21a, 21b and 21c is an explanatory diagram showing the notch grooves formed on the spine of the sheet bundle.

FIG. 22 is a perspective view showing the booklet wherein a spine split has occurred.

### DETAILED DESCRIPTION OF THE PREFERRED EMBODIMENTS

### Overview of the Bookbinding System

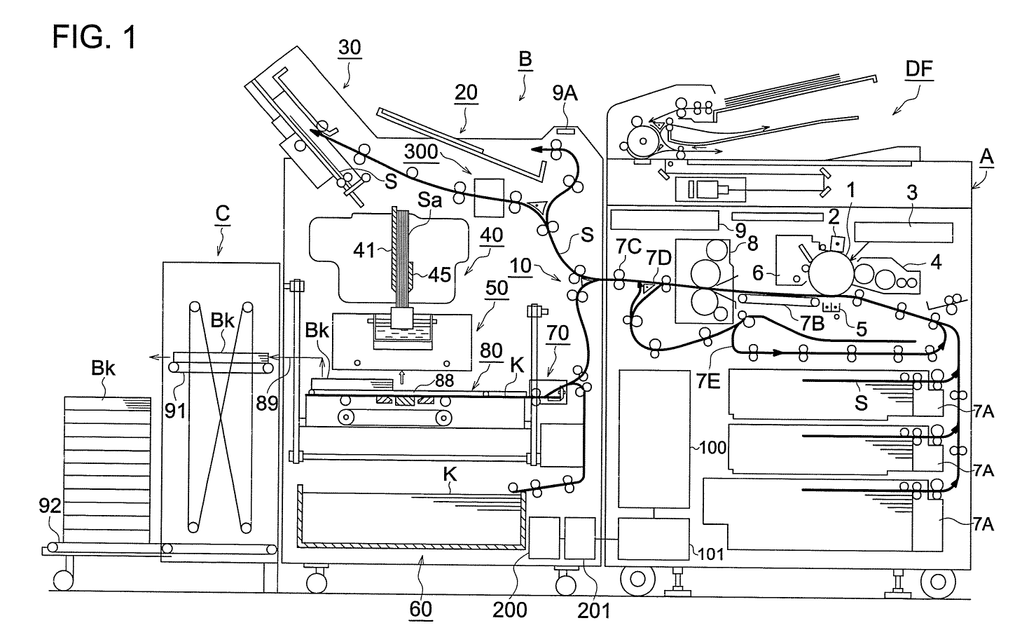

FIG. 1 is an overall schematic view representing a bookbinding system provided with an image forming apparatus A, bookbinding apparatus B, booklet storage apparatus C, and automatic document feeder DF.

The image forming apparatus A includes an image formation section which is provided with a rotating image carrier 1 and a charging section 2, image exposure section 3, development section 4, transfer discharger 5, and cleaning section 6 arranged around the rotating image carrier 1. After the surface of the image carrier 1 has been charged by the charging section 2, the image formation section performs exposure and scanning operations by the laser beam of the image exposure section 3 based on the image data captured from the document, whereby a latent image is formed. This latent image is developed by the development section 4, and a toner image is formed on the surface of the image carrier 1.

The sheet S fed from the sheet storage section 7A is conveyed to the transfer position of the image carrier 1. At the transfer position, the toner image is transferred onto the sheet S by the transfer discharger 5. After that, the electric charge on the surface of the sheet S is erased. The sheet S is separated from the image carrier 1 and is conveyed by the conveyance section 7B. After that, the toner image on the sheet S is heated and fixed onto the sheet S by the fixing section 8. The sheet S is ejected from the image forming apparatus A by the sheet ejection roller 7C.

When images are to be formed on both sides of the sheet S, the sheet S having been heated to have an image fixed thereon by the fixing section 8 is branched off from the ejection path by the conveyance path switching section 7D, and is switched back by the reverse conveyance section 7E so that the sheet S is reversed. The sheet S is again conveyed to the image formation section, whereby an image is formed on the rear of the sheet S. The sheet S ejected from the sheet ejection roller 7C is fed into the bookbinding apparatus B.

The operation section 9 is mounted on the upper portion of the image forming apparatus A. The contents of the job to be executed by the bookbinding system are inputted by the user through the operation section 9.

As shown in FIG. 1, the bookbinding apparatus B is a wrapping-type bookbinding apparatus including a conveyance path 10, sheet ejection section 20, reversing member 30, sheet bundle storage section 40, coating section 50, cover sheet supply section 60, trimming section 70, and booklet formation section 80. The present invention is also applicable to the glued bookbinding apparatus wherein sheet bundles are simply glued by adhesive, in addition to the wrapping-type bookbinding apparatus.

### [Block Diagram of the Bookbinding System]

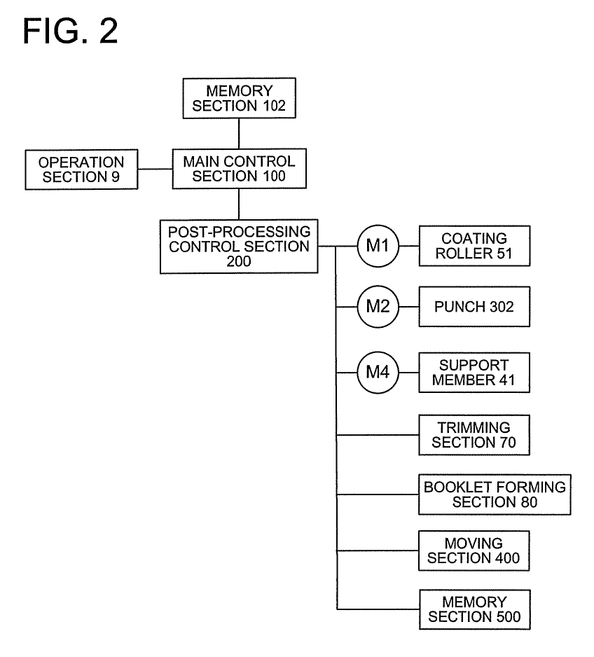

FIG. 2 is a block diagram representing a control system of the bookbinding system. The following describes only the representative components. The main control section 100 of the image forming apparatus A and the post-processing control section 200 of the bookbinding apparatus B are connected with each other by serial communication sections 101 and 201 (FIG. 1). In response to the command from the main control section 100, the post-processing control section 200 controls various components of the bookbinding apparatus B. In the present embodiment, the post-processing control section 200 serves as a control section.

The main control section 100 is connected with a memory section 102, which stores the pattern information of the notch grooves Va to be described later.

To bind a booklet, the post-processing control section 200 controls the drive of various sections to be described later. To be more specific, the post-processing control section 200 controls the operation of a motor M1 for driving a coating roller 51, a motor M2 for driving the punch 302 of a notching section 300, a motor M4 for driving the support member 41 that supports the sheet bundle, the trimming section 70, booklet formation section, and a moving section 400 for driving notching section 300. The memory section 500 stores the data received from the image forming apparatus A by the bookbinding apparatus B. Based on the stored data, the post-processing control section 200 controls the operations of the motor M1 and motor M2.

### [Overview of the Bookbinding Apparatus]

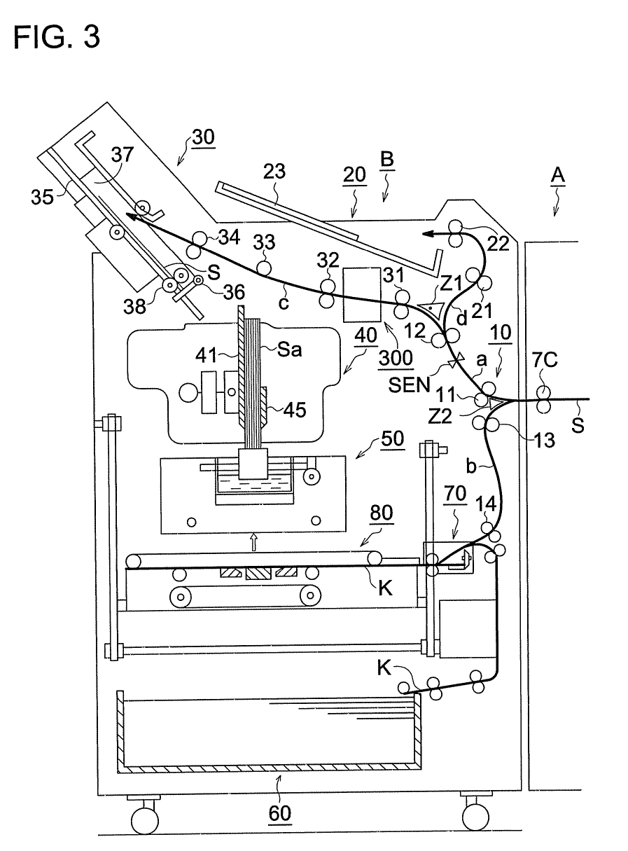

FIG. 3 is a cross sectional view showing the central portion of the bookbinding apparatus B. The conveyance path switching section Z2 arranged on the upstream side in the sheet feeding direction of the conveyance roller 11 ensures that the sheet S ejected from the image forming apparatus A is branched off to either the conveyance path “a” or conveyance path “b”. The sheet S conveyed to the conveyance path “a” is sandwiched and conveyed by the conveyance rollers 11 and 12, and is branched off to either the sheet ejection section 20 or reversing member 30 by the conveyance path switching section Z1. The sheet S having been conveyed to the conveyance path “b” is sandwiched by the conveyance roller 14, and is fed into the booklet formation section 80 that serves as a bookbinding section. A sheet detecting sensor SEN is mounted on the conveyance path “a”. This sheet detecting sensor SEN detects the sheet S conveyed along the conveyance path “a”.

When the sheet S is to be ejected to the sheet ejection section 20, the conveyance path switching section Z1 blocks the conveyance path “c” leading to the sheet bundle storage section 40, and opens the conveyance path “d” leading to the sheet ejection section 20. The sheet S passing through the conveyance path “d” leading to the sheet ejection section 20 is sandwiched by the conveyance roller 21 and is conveyed upward. This sheet S is then ejected into the fixed ejection tray 23 on the upper portion of the apparatus by the sheet ejection roller 22.

The sheet S branched off to the conveyance path “c” by the conveyance path switching section Z1 is sandwiched by the conveyance rollers 31, 32, 33 and 34, and is accommodated in a predetermined position of the reversing member 30. The reversing member 30 includes a sheet placement table 35 arranged at an inclined position, a positioning member 36 for determining the position of the trailing edge of the sheet, an alignment member 37 for aligning the sheet S across the width, and a conveyance roller 38.

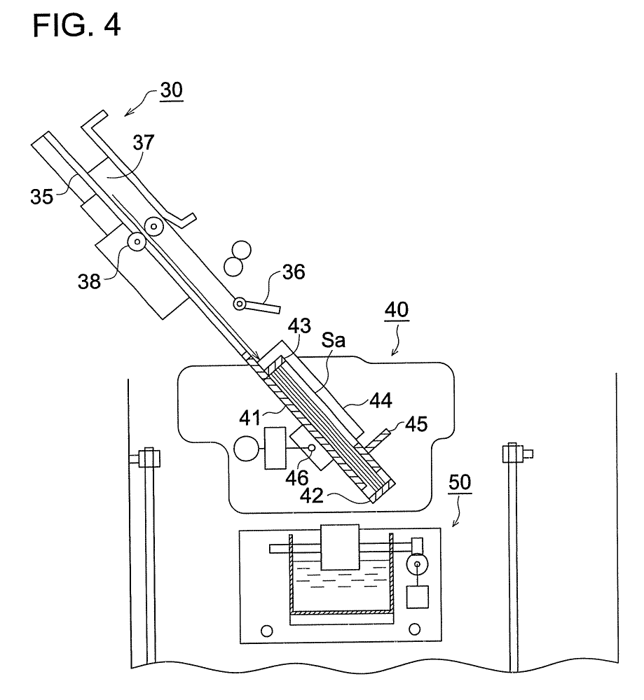

FIG. 4 is a cross sectional view showing that the sheet stacking section of the sheet bundle storage section 40 is inclined. The sheet bundle storage section 40 includes a support member 41, holder plate 42, lateral alignment member 44, and pressing member 45.

The sheet S placed on the sheet placement table 35 of a reversing member 30 is sandwiched by the conveyance roller 38, and is ejected from the opening formed by the rocking motion of a positioning member 36. The sheet S is then conveyed in a downward slanting direction. The sheet S is sequentially stacked in the sheet bundle storage section 40.

The sheet bundle storage section 40 includes a support member 41 having an inclined stacking surface and a holder plate 42 that can be rocked. The sheet S coming downward from the reversing member 30 slides down onto the stacking surface of the inclined support member 41, and is stopped when the leading edge of the sheet S has come in contact with the holder plate 42, whereby the sheets S are supported in the inclined state. The longitudinal alignment member 43 presses the trailing edge of the sheets S in conformance to the size of the sheets S placed on the stacking surface of the support member 41, so that the leading edges of the sheets S are brought in contact with the holder plate 42. This procedure ensures that the leading edges of the sheets S are aligned. The sheet S sequentially ejected from the image forming apparatus A is switched backed by the reversing member 30, and is stacked on the sheet bundle storage section 40, whereby a sheet bundle Sa made up of a plurality of sheets S is formed.

The size of the sheets S and the number of sheets of the sheet bundle Sa as the setting conditions of the booklet to be bound by the bookbinding apparatus B are set on the operation section 9 of the image forming apparatus A, or on an external device such as a personal computer linked to the image forming apparatus A.

The lateral alignment member 44 presses the side edge of the sheets S conveyed from the reversing member 30 and accommodated in the sheet bundle storage section 40 to achieve lateral alignment of the sheets across the width.

The sheet bundle Sa stacked on the sheet bundle storage section 40 is pressed by the pressing member 45 along the thickness, whereby the sheet bundle Sa is sandwiched. When a preset number of sheets S have been stored in the sheet bundle storage section 40, the pressing member 45 is driven by a motor (not illustrated), and the sheet bundle Sa is sandwiched by the support member 41 and pressing member 45.

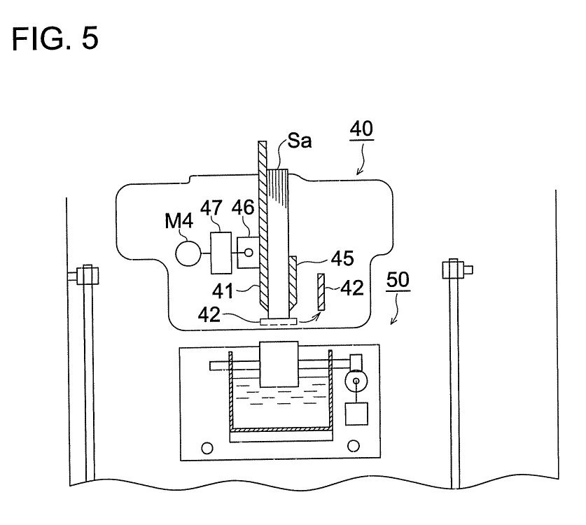

FIG. 5 is a cross sectional view showing that the sheet stacking section of the sheet bundle storage section 40 is in the upright position.

The support member 41 and pressing member 45 sandwiching the sheet bundle Sa are rotated around the axis 46 of the sheet bundle storage section 40 by the motor M4 and drive section 47 until the sheet bundle Sa in the inclined position is raised to the upright position. Under this condition, the lower surface of the sheet bundle Sa is apart from the coating roller 51 of the coating section 50. Further, when the sheet bundle Sa is sandwiched between the support member 41 and pressing member 45, the holder plate 42 is rotated from the position of the broken line to the position of the solid line by the drive section (not illustrated).

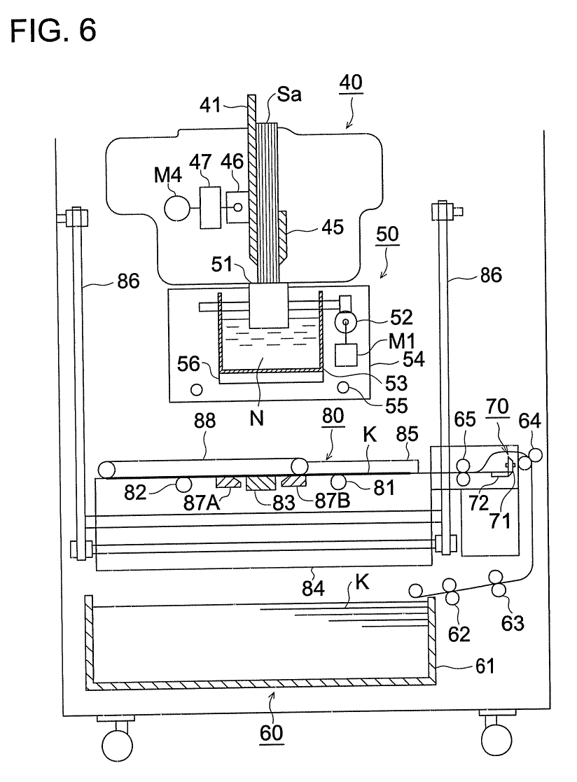

FIG. 6 is a cross sectional view showing a sheet bundle storage section 40, coating section 50, cover sheet supply section 60, trimming section 70, and booklet formation section 80.

The coating section 50 includes a coating roller 51, a drive section 52 for driving the coating roller 51, an adhesive container 53 for accommodating the adhesive N such as glue, a moving member 54 that supports the adhesive container 53 and can travel from the initial position at the rear of the bookbinding apparatus B to the coating position at the front, a moving device 55 that provides reciprocating motion of the moving member 54 and a heater 56 for heating the adhesive N accommodated in the adhesive container 53.

The moving member 54 of the coating section 50 is moved by the drive section (not illustrated) in the direction parallel to the lengthwise direction of the lower surface of the sheet bundle Sa held in an upright position by the support member 41 and pressing member 45.

The moving member 54 starts movement from the initial position at the rear of the bookbinding apparatus B, and travels along the moving device 55 until it is stopped at a predetermined position at the front of the bookbinding apparatus B. After that, the moving member 54 is reversed to get back to the initial position.

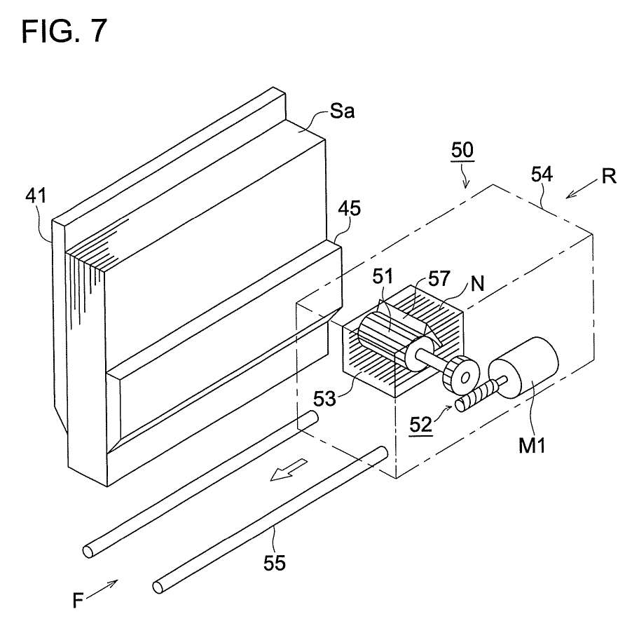

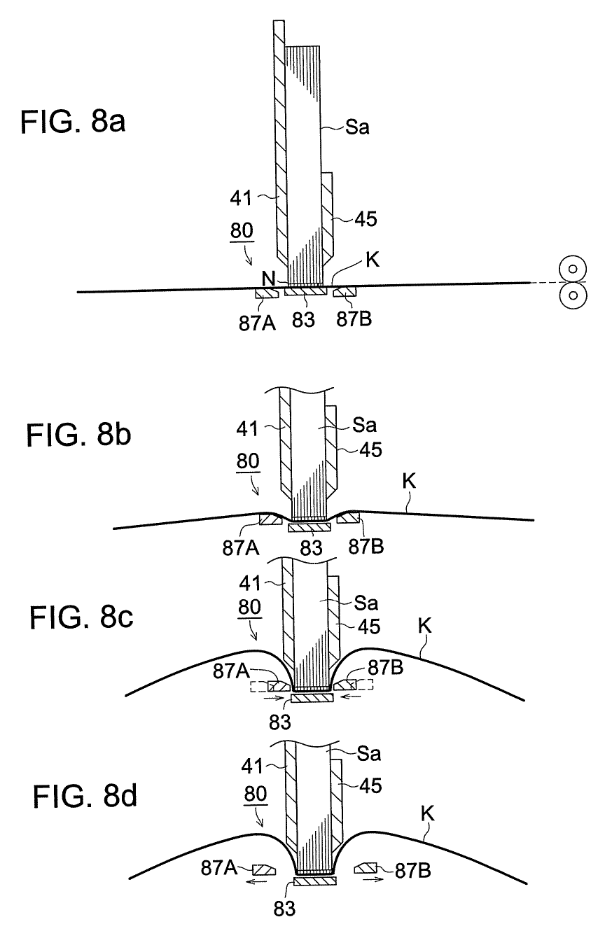

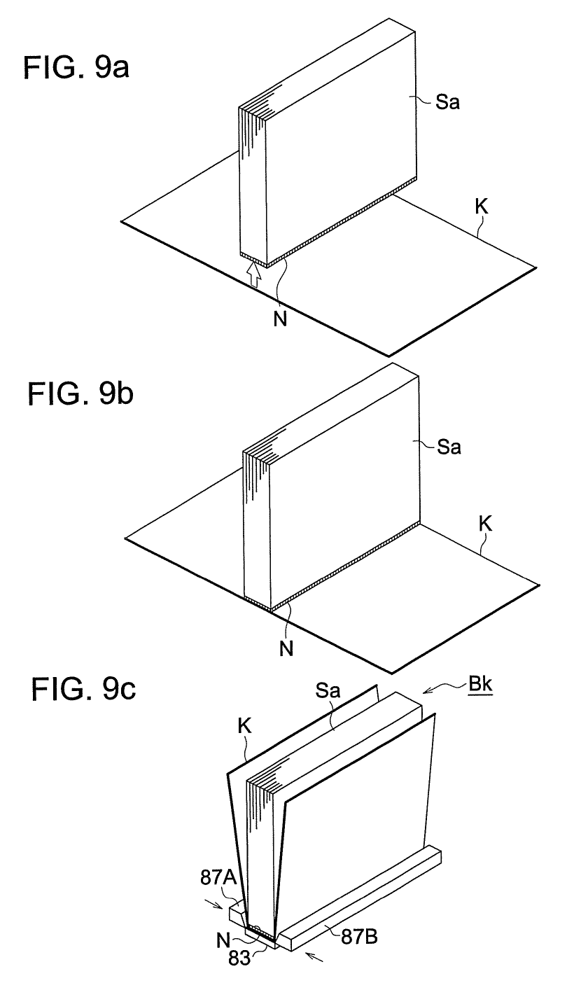

FIG. 7 is a perspective view representing the periphery of the coating section 50.

The coating roller 51 dipped in the adhesive container 53 accommodating the adhesive N is rotated by the motor M1 and drive section 52. The outward movement or reciprocating motion of the moving member 54 allows the coating roller 51 to apply the adhesive N on the lower surface of the sheet bundle Sa sandwiched in an upright position, along the length thereof from the rear side R toward the front side F.

The regulating member 57 regulates the thickness of the layer of adhesive N applied to the outer peripheral surface of the coating roller 51.

As shown in FIG. 6, the cover sheet K accommodated in the cover sheet stacking section 61 of the cover sheet supply section 60 is separated and fed by the sheet feed section 62. Being sandwiched by the conveyance rollers 63, 64 and 65, the cover sheet K is conveyed to the booklet formation section 80.

The trimming section 70 designed in an integrated structure with the booklet formation section 80 is located on the right of the booklet formation section 80 in the upward position of the cover sheet supply section 60 in the drawing. This trimming section 70 trims the cover sheet K along the length to a predetermined length, using the rotary cutter made up of a rotary blade 71 and stationary blade 72.

The predetermined length is obtained by adding the length of the spine of the sheet bundle Sa to the length of two sheets S in the traveling direction. For example, it is assumed that the cover sheet K is glued to the spine of the sheet bundle Sa made up of A4-sized sheets S and the folded bookbinding operation is performed and the maximum number of the sheets of the sheet bundle Sa is 300 and the thickness is about 30 mm. In this case, the predetermined length is set at 450 mm which is obtained by adding about 30 mm of the thickness of the sheet bundle Sa to two times 210 mm of short side length of the A4-sized sheet, and then the cover sheet K is trimmed (the overall length of the cover sheet K prior to trimming is 450 mm or more).

When a booklet is to be bound by the wrapping-type bookbinding operation of A5-sized, B5-sized and 8.5×11-inch (1 inch equivalent to 25.4 mm)-sized sheets S, a predetermined length is also set according to the length of the short side of the sheets and the thickness of the sheet bundle.

In the operation section 9 or external device of the image forming apparatus A, the control section sets the predetermined trimmed length of the cover sheet K, if the sheet size, number of sheets, and thickness of the sheets have been set or detected. The length of the cover sheet K prior to trimming is predetermined in response to the maximum number of sheets, and the sheets are stored in the cover sheet stacking section 61 of the cover sheet supply section 60.

The booklet formation section 80 includes conveyance rollers 81 and 82 that receive and convey the cover sheet K supplied from the cover sheet supply section 60 and stop it at a predetermined position, a pressurizing member 83 for pressing the cover sheet K against the adhesive coated surface of the sheet bundle Sa, a moving casing 84 for supporting the conveyance rollers 81 and 82 and the pressurizing member 83, an alignment section 85; and an elevating section 86 moving the moving casing 84 in the vertical direction.

The booklet formation section 80 and booklet ejection belt 88 formed integrally with each other are raised by the elevating section 86. When the booklet formation section 80 stops at the lower position to introduce the cover sheet K therein, the alignment section 85 moves from the initial position according to the size of the cover sheet K, and applies pressure to both sides of the cover sheet K across the width prior to the trimming operation, whereby alignment along the width is performed. The cover sheet K free of skew by means of widthwise alignment is switched back in the direction opposite to the direction of introduction. The cover sheet K is then conveyed to the trimming section 70 and is trimmed at a predetermined position.

Before the booklet formation section 80 glues the trimmed cover sheet K onto the spine of the sheet bundle Sa, the alignment section 85 moves from the initial position and presses both sides of the cover sheet K along the width again, whereby widthwise alignment is achieved at the lower position. Then the cover sheet K is stopped at a predetermined position. After that, the alignment section 85 goes back to the initial position without adversely affecting the bondage between the cover sheet K and sheet bundle Sa. This is followed by the step of upward traveling of the booklet formation section 80. At the time of upward traveling, the cover sheet K is supported at a predetermined position.

Accordingly, the alignment section 85 installed on the booklet formation section 80 capable of vertical travel determines the position of the cover sheet K across the width before and after the trimming of the cover sheet K by the trimming section 70. This procedure implements improvement of the cover sheet trimming precision, enhancement of positioning accuracy between the sheet bundle Sa and cover sheet K, and simplification of the structure.

The elevating section 86 moves the moving casing 84 to the upper position by rotating the belts on the right and left. In this upward traveling position, the center of the cover sheet K placed on the pressurizing member 83 is pressed against the surface coated with adhesive of the sheet bundle Sa, whereby the cover sheet K is glued with the sheet bundle Sa. Upon termination of the sheet bundle Sa being coated with adhesive, the coating section 50 travels backward and goes to the retracted position.

The cover sheet folding section is mounted on the top of the booklet formation section 80. The cover sheet folding section includes a pair of bilaterally symmetrical forming members 87A and 87B. The forming members 87A and 87B can be touchable and detachable with the sheet bundle Sa along the thickness of the sheet bundle Sa. The forming members 87A and 87B fold the cover sheet K along the side edge of the adhesive-coated surface of the sheet bundle Sa, and lay the front cover sheet and back cover sheet on top of the front and rear sides of the sheet bundle Sa.

Upon termination of the step of folding the cover sheet K, the booklet formation section 80 is lowered a predetermined distance by the downward drive of the elevating section 86, and is stopped after having retracted. After that, when the holding operation by the holding section has been turned off, the booklet Bk drops and the spine on the lower surface of the booklet Bk comes in contact with the top surface of the booklet ejection belt 88. The booklet Bk is placed in position and is ejected.

Each of FIGS. 8a, 8b, 8c and 8d is a cross sectional view showing the booklet formation section 80 and sheet bundle Sa, and illustrates the cover sheet K folding process. FIG. 8a shows the start of the operation of folding the cover sheet. FIG. 8b shows the process of the cover sheet being folded. FIG. 8c shows the termination of the folding operation. FIG. 8d shows that the cover sheet folding pressure has been turned off.

Each of FIGS. 9a-9c is a perspective view representing the booklet Bk binding process using the sheet bundle Sa and cover sheet K. FIG. 9a is a perspective view representing the cover sheet K and sheet bundle Sa before the cover sheet is glued. FIG. 9b is a perspective view showing the sheet bundle Sa with cover sheet K glued thereon. FIG. 9c is a perspective view representing the booklet Bk produced by folding the cover sheet K while wrapping the sheet bundle Sa with the cover sheet K.

After the cover sheet K is glued onto the sheet bundle Sa coated with adhesive N, the forming members 87A and 87B are driven by a drive section (not illustrated) when the booklet formation section 80 is located at the upward position as shown in FIGS. 8a-8d. The cover sheet K is sandwiched between the forming members 87A and 87B, and is deformed from the side edge of the adhesive-coated surface of the sheet bundle Sa (FIG. 8b). After that, the forming members 87A and 87B move in the horizontal direction toward the adhesive-coated surface of the sheet bundle Sa, and form the cover sheet K by pressing both sides of the sheet bundle Sa, whereby the booklet Bk is produced.

### [Overview of the Notch]

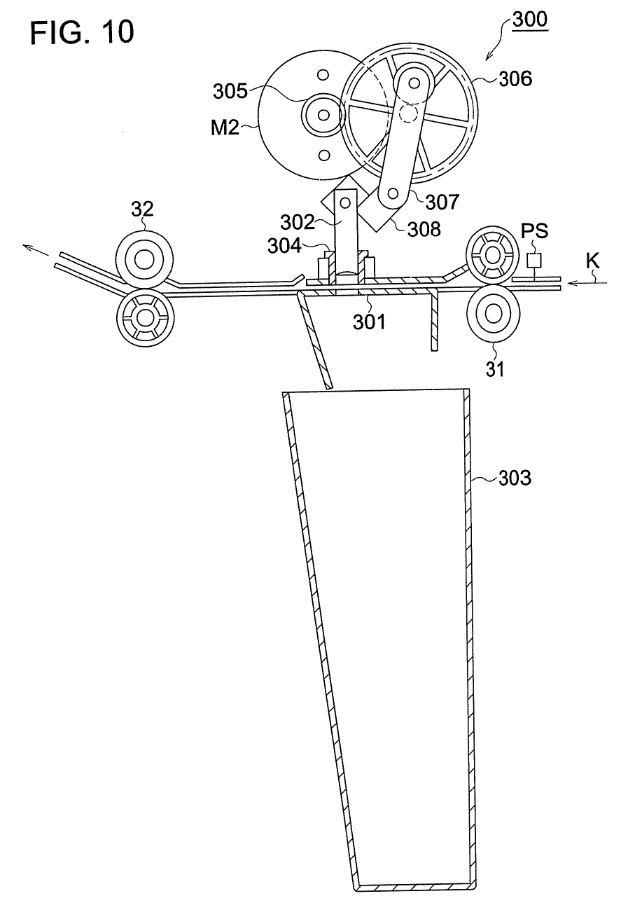

FIG. 10 is a cross sectional view of a notching section 300. The notching section 300 includes a die 301 fixed on the conveyance path of sheet S, a punch 302 moving upward to fit into the die 301, a drive section for providing vertical traveling of the punch 302, and a sheet scrap container 303 for accommodating the sheet scrap generated at the time of notch processing.

The outer peripheral surface of the punch 302 opposed to the die 301 is fitted to the inner surface of the guide member 304 movably in the vertical direction. The drive section for providing vertical traveling of the punch 302 includes a motor M2; a small gear 305 connected with the motor M2; a large gear 306 meshing with the small gear 305; a crank 307 engaged to one edge of the large gear 306 and capable of rocking; and a connecting member 308 for connection between the crank 307 and the upper portion of the punch 302. The punch 302 is driven in the vertical direction by the motor M2 through the small gear 305, large gear 306, crank 307 and connecting member 308. Notches V (FIGS. 11a-11d) are formed on the trailing edge of the sheets S by the lower movement of the punch 302 and fitting with the die 301.

Each of FIGS. 11a-11d is a plane view showing the sheet containing notches and perforations formed thereon.

The notch V formed on the trailing edge of the sheets S is shaped like capital V or U, in addition to a semicircle shown in FIGS. 11a and 11b. For example, the notch V can be formed by a punch and die used for the commonly used sheet files.

The numbers of the notches V and perforations “h” formed on the sheet S can be set as desired, by adjusting the numbers of the punches and dies. Two notches V of FIG. 11a have a hole diameter of φ6 mm and a space of φ80 mm between the holes. Three notches V of FIG. 11b have a hole diameter of φ6 mm and a space of φ108 mm between the holes. Two circular perforations “h” of FIG. 11c have a hole diameter of φ6 mm and a space of φ80 mm between the holes. The three perforations “h” of FIG. 11d have a hole diameter of φ6 mm and a space of φ108 mm between the holes.

In the operation section 9 of the image forming apparatus A, when the perforation processing and notch processing are not set, each of the sheets S ejected from the image forming apparatus A passes through the notching section 300 without being processed, and the sheets S are coated with adhesive.

In the operation section 9, when notch processing for forming notches V is set, the trailing edge of each of the sheets S is detected by the sensor PS (FIG. 10). After that, the pulses more than the predetermined pulses at the time of punching out the perforation “h” are counted and the sheet S is conveyed and stopped. After that, notches V are formed close to the trailing edges of the sheets S (FIGS. 11a and 11b).

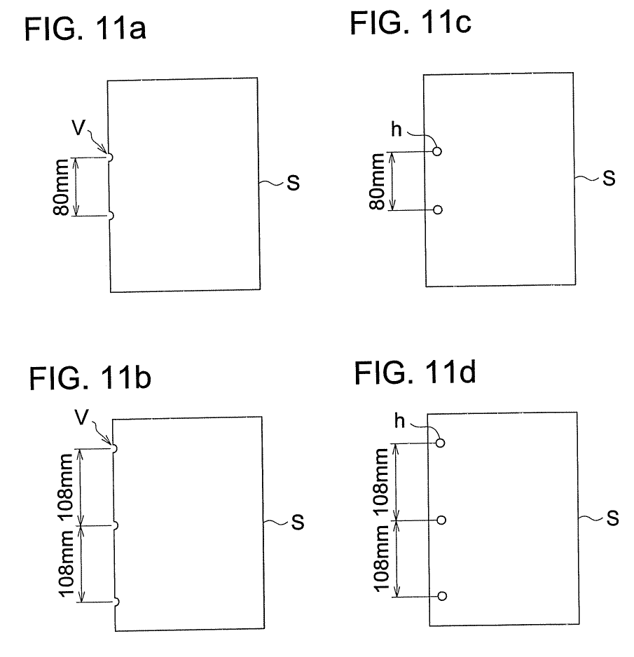

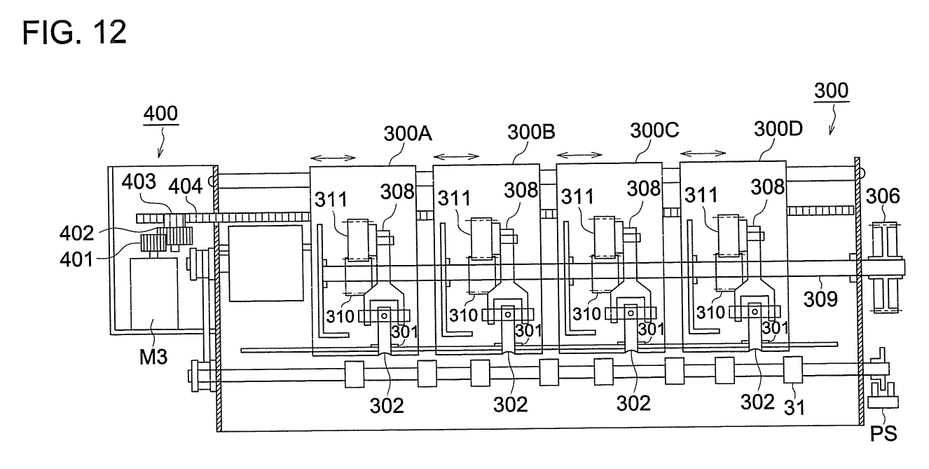

In the operation section 9, when the perforation processing for punching the circular perforation “h” is set, the sensor PS (FIG. 10 or FIG. 12) detects that the trailing edge of each of the sheets S sandwiched and conveyed by the conveyance roller 31 and conveyance roller 32 has passed. Then the predetermined pulses are counted, the motor for the sheet conveyance (not illustrated) is stopped, whereby the feeding of the sheet S is stopped. Perforations “h” are formed close to the trailing edges of the sheets S where the sheet has stopped (FIGS. 11c and 11d).

FIG. 12 is a front view of a notching section 300 and moving section 400.

The moving section 400 moves the notch forming sections 300A, 300B, 300C and 300D each having a punch 302 and die 301 in the lateral direction of FIG. 12 (in the horizontal direction perpendicular to the direction wherein the sheet S is conveyed). The positions of the notches V formed on the sheet S are changed by the lateral traveling of the notch forming sections 300A, 300B, 300C and 300D.

If the motor M3 is driven, the rack gear 404 moves in the lateral direction of FIG. 12 through the gear train made up of gears 401, 402 and 403. Rack gear 404 is engaged with the notch forming sections 300A, 300B, 300C and 300D, and the notch forming sections 300A, 300B, 300C and 300D are moved in the lateral direction (FIG. 12) by the traveling of the rack gear 404. In FIG. 12, four notch forming sections are illustrated, a desired number of notch forming sections can be installed in conformance to the number of the notches or perforations to be provided on the sheet S. Further, in the present embodiment, the notch forming device is composed of the post-processing control section 200, notch forming sections 300A, 300B, 300C and 300D, and moving section 400.

### [Overview of the Notch Groove]

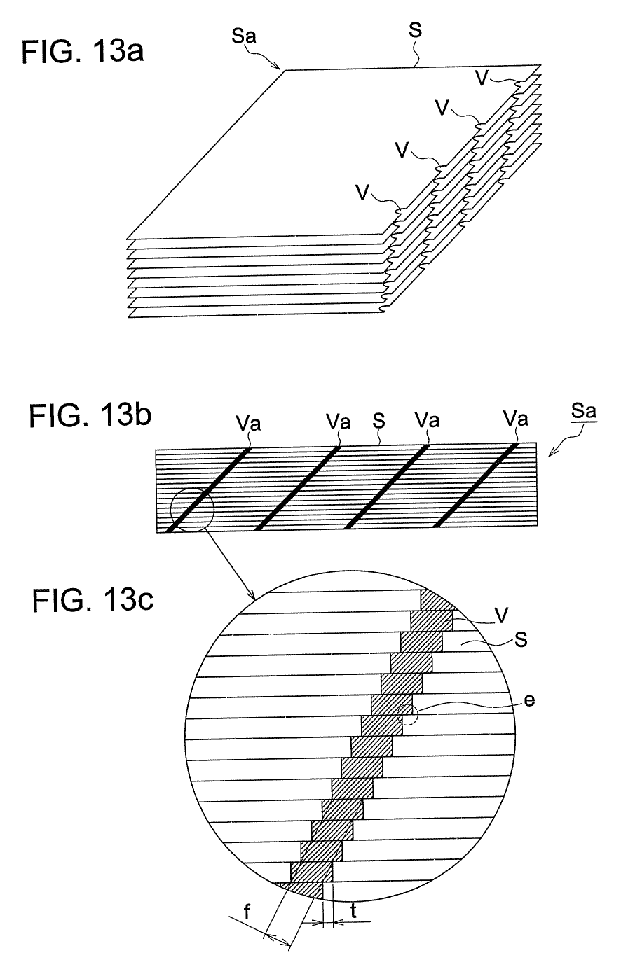

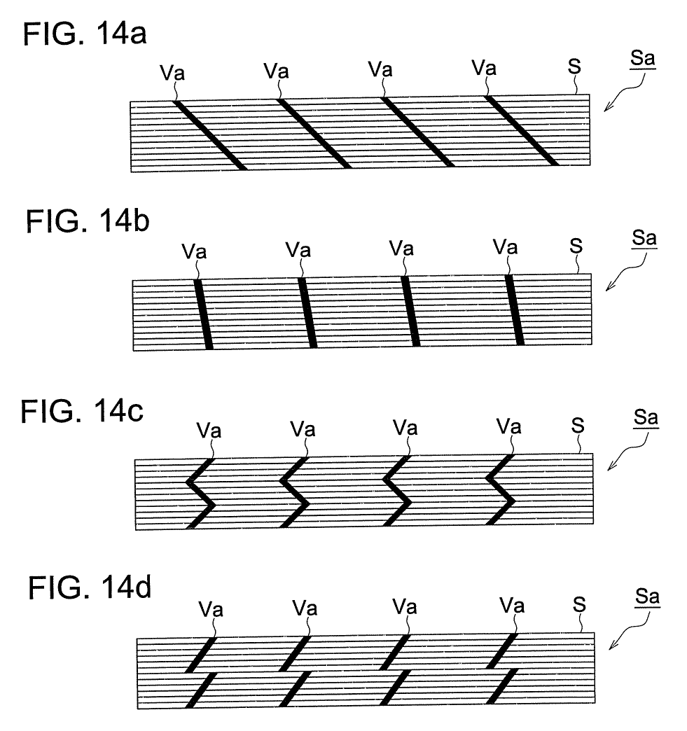

FIG. 13a is a perspective view showing the sheet bundle Sa formed of the sheets S having notches V. FIG. 13b is a front view of the spine of the sheet bundle Sa. FIG. 13c is a partially enlarged view of the spine of the sheet bundle Sa.

As shown in FIG. 13a, four notches V are formed on the edge of each sheet S. The sheets S containing notches V are bundled and notch grooves Va are formed on the spine of the sheet bundle Sa. As shown in FIG. 13b, four notch grooves Va are formed on the spine of the sheet bundle Sa. Four notch grooves Va are formed approximately at equally spaced intervals to form a surface to be filled with adhesive. In this state, the spine of the sheet bundle Sa is coated with adhesive N by the coating section 50 of FIG. 5. The adhesive N is applied to the spine and enters the notch grooves Va, whereby an adhesive surface is formed.

Entry of the adhesive into the notch grooves Va formed on the spine of the sheet bundle Sa increases the adhesive strength on the spine of the sheet bundle Sa. This prevents the sheets S that have insufficient adhesive strength from falling out of the booklet Bk produced by gluing the cover sheet K to the sheet bundle Sa when the booklet is open.

The notch grooves Va of FIG. 13b are formed as a pattern in a slanting direction. As shown in FIG. 13c, this pattern is formed by the horizontal movement of positions of the notches V for every sheet. When the positions of the notches V are changed for each sheet, adhesive adheres the displaced portion (area “e” in FIG. 13c), whereby adhesive strength between the sheets is enhanced.

As shown in FIG. 13c, the position of the notch V is changed by a traveling distance “t” for each sheet. The width of the notch grooves Va formed by the notches V is represented by “f” in FIG. 13c. The amount of the adhesive entering the notch grooves Va differs according to the width f of the notch grooves Va, and therefore, it is preferred that the traveling distance “t” should be adjustable.

As shown in FIGS. 13a-13c, to change the position of the notches V for each sheet in the horizontal direction, the post-processing control section 200 controls the operation of the moving section 400 in such a way that the notch forming sections 300A, 300B, 300C, and 300D are moved in the horizontal direction for each sheet. Further, as shown in FIG. 13c, enhanced adhesive strength can be obtained by changing the position of the notches V for every sheet. However, to simplify the control procedure, the position of the notches V can be changed every plural sheets (e.g., every two sheets).

### [Pattern of the Notch Groove]

In the bookbinding apparatus B, there are a plurality of patterns of the notch grooves Va formed on the spine of the sheet bundle Sa. An appropriate pattern of the notch grooves Va is formed in conformance to the settings of the booklet production job executed by the bookbinding apparatus B. This will be described below.

Each of FIGS. 14a-14d is an explanatory diagram showing the pattern of the notch grooves Va formed on the sheet bundle Sa. In the bookbinding apparatus B of the present embodiment, four patterns of the notch grooves Va shown in FIGS. 14a-14d are formed on the sheet bundle Sa.

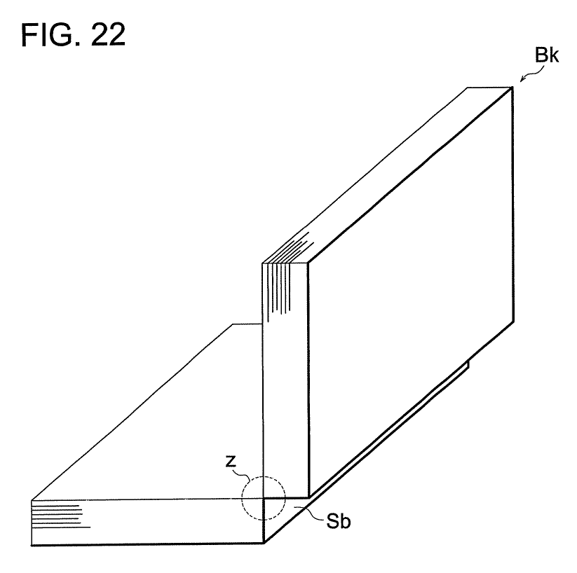

The patterns of the notch grooves Va of each of FIGS. 14a-14d have different characteristics. This will be described with reference to each pattern. FIG. 14a shows the pattern wherein the notch grooves Va are oblique. In the pattern of FIG. 14a, the notch positions are misaligned among sheets in the lateral direction, and therefore, a sufficient adhesive strength among sheets is ensured. This protects the sheets S against accidental removal from the produced booklet. However, this is not sufficient to protect against the so-called “spine split” wherein the spine Sb of the sheet bundle Sa is broken and split (area “z” in FIG. 22) when the booklet Bk is wide open, as shown in FIG. 22. Thus, the pattern of FIG. 14a is suitable for the production of a booklet using the coated paper or machine coated paper wherein sheets S easily drop off. This pattern is also suitable for production of a booklet using a smaller number of sheets wherein spine splitting hardly occurs.

FIG. 14b shows the pattern wherein the notch grooves Va are formed substantially straight in the transverse direction. The pattern of FIG. 14b is less susceptible to the spine split described with reference to FIG. 22. However, there is not sufficient misalignment of the notch positions in the lateral direction among sheets, and therefore, adhesive strength among sheets is not sufficient and sufficient protection is not provided against removal of some of the sheets from the bound booklet. Thus, the pattern of FIG. 14b is suited for the production of a booklet consisting of a great number of sheets wherein a spine split tends to occur. This pattern is also suited for the production of a booklet using plain paper wherein the adhesive strength among sheets can easily be provided.

FIG. 14c shows the pattern wherein the notch grooves Va are curved in a zigzag manner. The pattern of FIG. 14c is effective for protection against both the spine split and accidental removal of sheets from a booklet, as described with reference to FIG. 22. Accordingly, this pattern is suited for the production of any type of booklet, particularly for the production of a booklet consisting of a considerable number of sheets.

FIG. 14d shows the pattern wherein a notch grooves Va in a slanting direction are divided. The pattern of FIG. 14d is not sufficient to protect against the spine split described with reference to FIG. 22. However, this pattern makes it easier to open the booklet, and to maintain the booklet in an opened state without holding it by hand. Thus, the pattern of FIG. 14d is suitable for the production of a booklet consisting of a great number of sheets which makes the booklet not to be opened easily.

As described above, each pattern of the notch grooves Va has a different characteristic. Thus, it is preferred that the pattern of the notch grooves Va suited for each job be selected based on the job settings for bookbinding, and the selected pattern of the notch grooves Va should be formed on the spine of the sheet bundle Sa. (For example, in the case of binding a booklet wherein the accidental removal of sheets S from the booklet hardly occurs, a pattern effectively minimizing removal of the sheets S is preferably selected and the selected pattern is preferably formed on the spine of the sheet bundle Sa). Thus, in the bookbinding system, the notch grooves Va of the different patterns according to the settings of the job to be executed are formed on the edge of the sheet bundle Sa.

The pattern of the notch grooves Va is automatically selected according to the settings such as the type of sheets S and the number of sheets constituting the sheet bundle Sa set by the user when the booklet binding job is set. Alternatively, the pattern is directly selected by the user when the booklet binding job is set.

The following describes the way wherein the pattern of the notch grooves Va is automatically selected according to the settings such as the type of sheets S and the number of sheets constituting the sheet bundle Sa for each booklet which are set by the user.

Before the booklet binding job is executed, the user sets the information such as the type of sheets S to be outputted through the operation section 9 of the image forming apparatus A. Further, when a booklet is to be bound by the bookbinding system which receives the booklet binding job from the external terminal, the user sets such information as the type of sheets S to be outputted through the external terminal.

The information to be set by the user includes the type of sheets S, the basis weight of the sheets S, the number of sheets constituting a sheet bundle Sa, and the thickness of the sheet bundle Sa. In the present embodiment, when the user has set the aforementioned information, the appropriate pattern of notch grooves Va is automatically selected based on the settings. The selection operation is performed by the main control section 100 of the image forming apparatus A according to a predetermined program. The appropriate pattern of the notch grooves Va is automatically selected by referencing the pattern tables shown in the following Tables 1 through 4 (wherein the pattern tables are stored in the memory section 102).

In the booklet binding job, when the user has set the type of sheets S through the operation section 9, the appropriate pattern is selected by reference to the following Table 1. In the Tables 1 through 4, the pattern of the notch grooves Va shown in FIG. 14a is “pattern 1” and the pattern of the notch grooves Va shown in FIG. 14b is “pattern 2”. The pattern of the notch grooves Va shown in FIG. 14c is “pattern 3” and the pattern of the notch grooves Va shown in FIG. 14d is “pattern 4”.

TABLE 1

Type of sheet

| | | Coated paper |
|---|---|---|
| | Plain paper | Quality paper |
| | Recycled paper | Book paper |
| Pattern 1 | | Appl. |
| Pattern 2 | Appl. | |
| Pattern 3 | Appl. | |
| Pattern 4 | Appl. | |

As shown in Table 1, when the plain paper or recycled paper has been selected by the user as the type of sheets S outputted for booklet binding, one of the patterns 2 through 4 is selected as the appropriate pattern. When a coated paper, quality paper, or book paper has been selected as the type of sheets S, pattern 1 is selected as the appropriate pattern.

When the user has set the basis weight of the sheets S on the operation section 9, an appropriate pattern is selected by reference to the pattern table of the following Table 2. The basis weight of the sheets S refers to the weight of the sheets S per unit area (per square meter) represented in terms of “g”.

TABLE 2

| | Basis weight [g/m²] | | |
|---|---|---|---|
| | 40 to 71 | 72 to 161 | 162 to 300 |
| Pattern 1 | | | Appl. |
| Pattern 2 | | Appl. | |
| Pattern 3 | | Appl. | |
| Pattern 4 | Appl. | | |

As shown in Table 2, when the sheets S having a basis weight of 40 through 71 g/m² have been selected by the user as the sheets to be outputted for booklet binding, pattern 4 is selected as the appropriate pattern. When the sheets S having a basis weight of 72 through 161 g/m² have been selected as the sheets to be outputted for booklet binding, either pattern 2 or pattern 3 is selected as the appropriate pattern. When the sheets S having a basis weight of 162 through 300 g/m² have been selected as the sheets to be outputted for booklet binding, pattern 1 is selected as the appropriate pattern.

When the number of sheets of the sheet bundle Sa for each booklet is set by a user through the operation section 9, the appropriate pattern is selected according to the pattern table of the following Table 3. If the number of sheets in the sheet bundle Sa is not set by the user, it is possible to make such arrangements, for example, that the documents are counted in the automatic document feeder DF, and the number of sheets in the sheet bundle Sa is calculated based on the count of the documents. Thus, the appropriate pattern is selected based on the calculation result according to the pattern table of the following Table 3.

TABLE 3

| | Number of sheets | | |
|---|---|---|---|
| | in sheet bundle | | |
| | 10 to 69 | 70 to 150 | 151 to 300 |
| Pattern 1 | Appl. | | |
| Pattern 2 | | Appl. | |
| Pattern 3 | | | Appl. |
| Pattern 4 | | | Appl. |

As shown in Table 3, if the number of sheets in the sheet bundle Sa set by the user is in the range of 10 through 69, pattern 1 is selected as an appropriate pattern. If the number of sheets in the sheet bundle Sa set by the user is in the range of 70 through 150, pattern 2 is selected as an appropriate pattern. If the number of sheets in the sheet bundle Sa set by the user is in the range of 151 through 300, either pattern 3 or pattern 4 is selected as an appropriate pattern.

If the user has set the thickness of the sheet bundle Sa for each booklet through the operation section 9, the appropriate pattern is selected according to the pattern table given in Table 4. If the thickness of the sheet bundle Sa is not set by the user, it is possible to make such arrangements, for example, that the documents are counted in the automatic document feeder DF, and the thickness of the sheet bundle Sa is calculated based on the count of documents. Thus, the appropriate pattern is selected based on the calculation result according to the pattern table of the following Table 4.

TABLE 4

| | Thickness of sheet bundle [mm] | | |
|---|---|---|---|
| | 1.0 to 6.9 | 7.0 to 15.0 | 15.1 to 30.0 |
| Pattern 1 | Appl. | | |
| Pattern 2 | | Appl. | |
| Pattern 3 | | | Appl. |
| Pattern 4 | | | Appl. |

As shown in Table 4, if the thickness of the sheet bundle Sa set by the user is in the range of 1.0 through 6.9 mm, pattern 1 is selected as an appropriate pattern. If the thickness of the sheet bundle Sa set by the user is in the range of 7.0 through 15.0 mm, pattern 2 is selected as an appropriate pattern. If the thickness of the sheet bundle Sa set by the user is in the range of 15.1 through 30.0 mm, either pattern 3 or pattern 4 is selected as an appropriate pattern.

When the user has set the type of sheets S, the basis weight of the sheets S and the number of sheets constituting the sheet bundle Sa in one job, an appropriate pattern is selected based on the setting of the type of sheets S as a priority item. For example, if settings are made in such a way that the type of sheets S is coated paper, the basis weight of the sheets S is in the range from 40 through 71 g/m², and the number of sheets in the sheet bundle Sa for each copy of the booklet is in the range from 70 through 150, then pattern 1 is selected based on the setting of the type of sheets S as a priority item.

If a plurality of appropriate patterns can be selected based on Table 1 through Table 4, pattern 3 is selected in preference to the pattern 4, pattern 2 is selected in preference to pattern 3, and pattern 1 is selected in preference to pattern 2. For example, if the type of sheets S is plain paper, without other items being set, pattern 2 through pattern 4 can be selected according to Table 1. However, priority is given to pattern 2 so that pattern 2 is selected as an appropriate pattern.

As described above, if the pattern of the notch grooves Va is automatically selected according to the type of sheets S and the number of sheets in the sheet bundle Sa for each copy of the booklet which are set by the user, a binding procedure of properly bonded booklet can be performed.

The following describes the method wherein the pattern of the notch grooves Va is selected directly by the user at the time of setting the booklet binding job (i.e., the method wherein the pattern is selected based on the setting contents relating to the pattern of the notch grooves Va selected by the user)

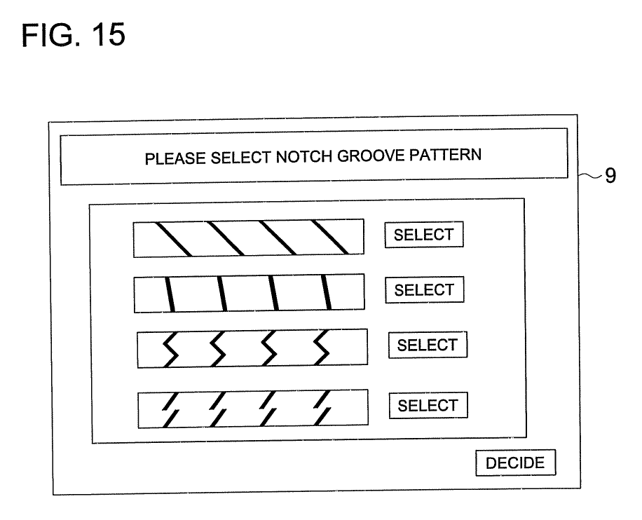

FIG. 15 is an explanatory diagram showing the pattern of the notch grooves Va which is displayed on the operation section 9 for selection by a user.

When the booklet binding job is set, the patterns of a plurality of notch grooves Va stored in the memory section 102 are displayed on the operation section 9 as shown in FIG. 15. Taking into account the characteristics of the booklet to be outputted, the user selects any one of the patterns of notch grooves displayed on the operation section 9. The pattern of the notch grooves Va is selected by pressing the selector button located on the side of the picture representing the pattern as shown in FIG. 15. It is possible to make such arrangements that, in addition to the picture showing the pattern, descriptions of the characteristics of various patterns (e.g., pattern resistant to a spine split) are displayed for ease of selection.

As described above, usability is enhanced by ensuring that the patterns of the notch grooves Va can be easily selected by the user at the time of setting the booklet binding job.

### [Control Operation for the Formation of Notch Grooves]

The following describes the procedure wherein notches are formed on the sheets S by the bookbinding apparatus B according to the pattern of the notch grooves Va selected in the image forming apparatus A.

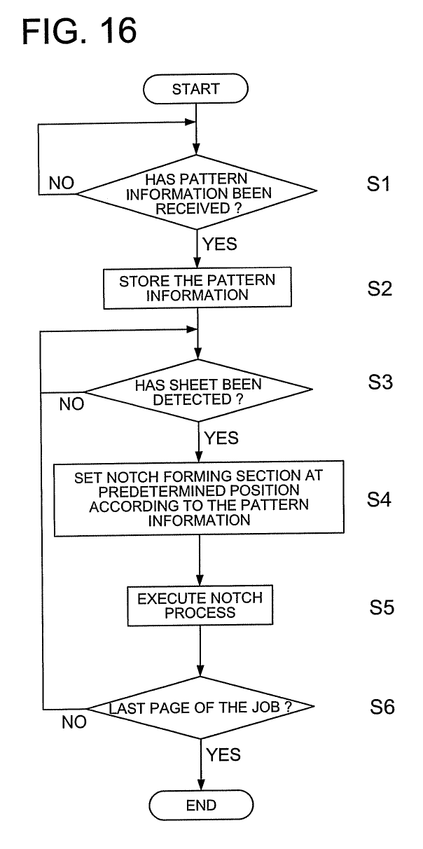

FIG. 16 is a flow chart showing the procedure of forming notches according to the pattern of the notch grooves. The operations of FIG. 16 are intended to bind a copy of a booklet. The decision steps (Steps S1, S3 and S6) of FIG. 16 are performed by the post-processing control section 200 of the bookbinding apparatus B.

An appropriate pattern of the notch grooves Va is selected in the image forming apparatus A according to the aforementioned method. When job execution has started, a step is taken to determine whether or not the information on the selected pattern of the notch grooves Va has been received by the bookbinding apparatus B from the image forming apparatus A (Step S1). This pattern information serves to allow the post-processing control section 200 operate the notch forming sections 300A, 300B, 300C, and 300D of the bookbinding apparatus B (FIG. 12).

When it has been determined that pattern information has been received in the bookbinding apparatus B (Step S1: Yes), the received pattern information is temporarily stored in the memory section 500 of the bookbinding apparatus B. The sheet detecting sensor SEN installed on the conveyance path “a” detects whether or not sheet S has been conveyed in the bookbinding apparatus B (Step S3).

When the sheet detecting sensor SEN has detected that the sheet S has been conveyed (Step S3: Yes), the moving section 400 sets the notch forming sections 300A, 300B, 300C, and 300D at predetermined positions based on the pattern information received and stored in Steps S1 and S2 (Step S4). Notch processing is applied to the sheet S having been conveyed (Step S5), and notches V are formed at predetermined positions on the sheet S.

Then a step is taken to determine whether or not the sheet S having been subjected to notch processing corresponds to the final page of the job (Step S6). If it is not the final page, the procedures of Step S3 through Step S5 are repeated. Thus, the pattern of the notch grooves Va selected by the image forming apparatus A is formed on the spine of the sheet bundle Sa, whereby an appropriately glued booklet Sa is produced.

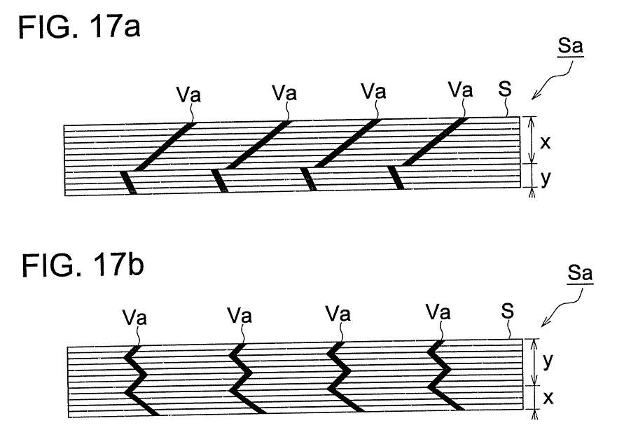

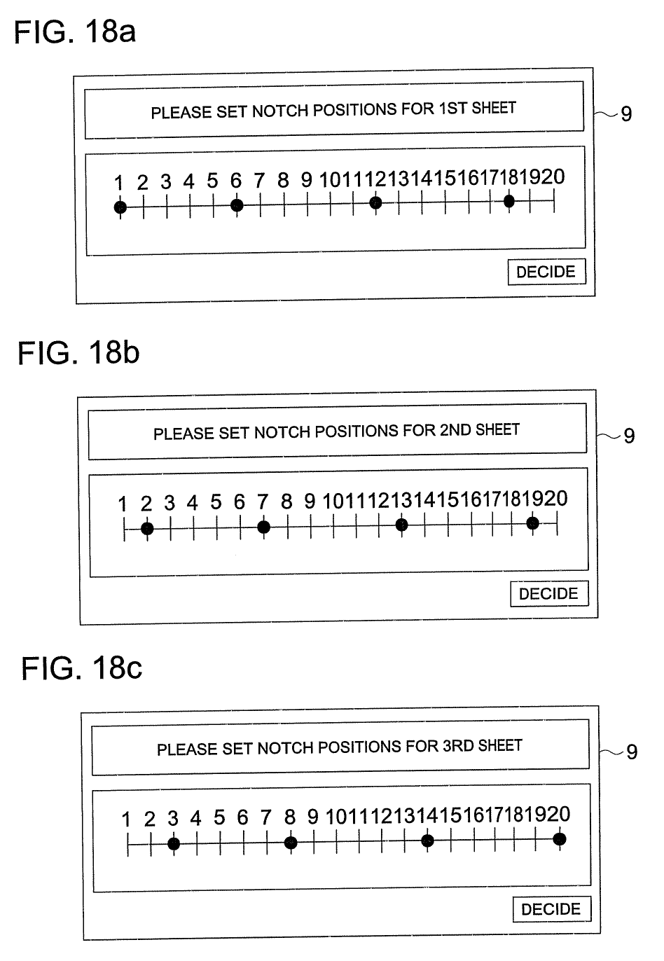

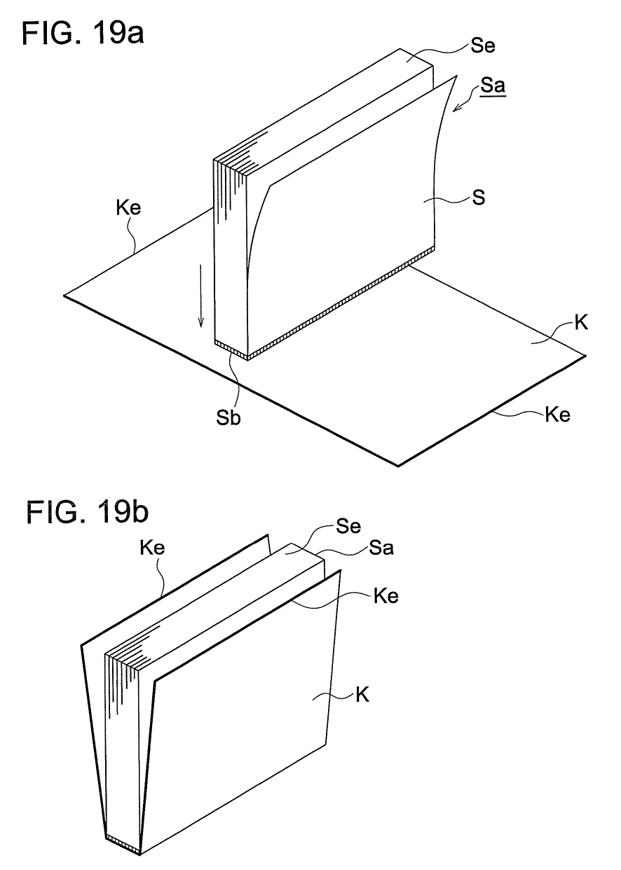

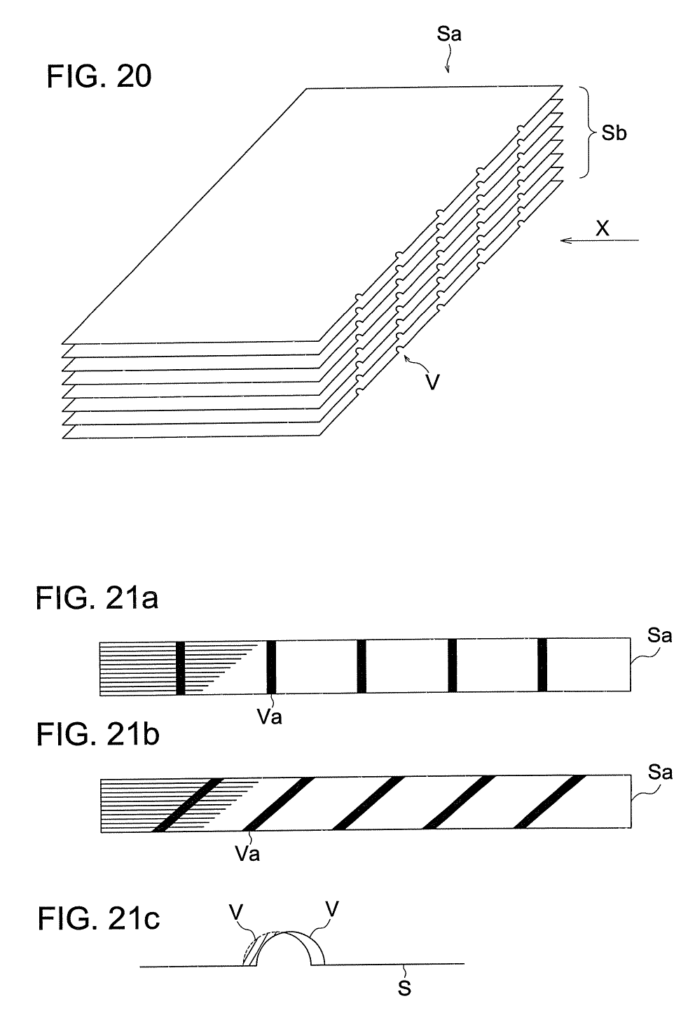

It should be noted that the pattern of the notch grooves Va is not restricted to the four patterns of FIGS. 14a-14d. Various other patterns can also be used. Each of FIGS. 17a and 17b is an explanatory diagram showing the other pattern of notch grooves Va formed on the sheet bundle. When the sheet bundle Sa is composed of different types of sheets, the notch grooves Va are formed according to the pattern of FIG. 17a or FIG. 17b. The area “x” in each of FIGS. 17a and 17b corresponds to the portion composed of coated paper sheets, and the area “y” in each of FIGS. 17a and 17b corresponds to the portion composed of plain paper sheets. The coated paper sheets tend to fall out of the booklet. Accordingly, the area “x” composed of the coated paper sheets includes the pattern largely inclined. The plain paper sheets do not easily fall out of the booklet. Accordingly, the area “y” composed of the plain paper sheets includes the pattern which is slightly less inclined as compared to the area “x” for the purpose of avoiding a possible spine split.

The pattern of FIG. 17a is suited for binding a booklet wherein a plurality of types of sheets are included and there are not many sheets in the sheet bundle Sa (e.g., about 70 through 80 sheets). The pattern of FIG. 17b is suited for binding a booklet wherein a plurality of types of sheets are included and there are many sheets in the sheet bundle Sa (e.g., about 250 through 300 sheets).

In addition to the method of selecting the pattern of the notch grooves Va registered in the bookbinding system in advance, it is possible to use the method wherein the pattern of the notch grooves Va is inputted by the user through the operation section 9, and notch grooves Va are prepared by the inputted pattern. Each of FIGS. 18a-18c is an explanatory diagram showing the setting screen of the operation section 9 for inputting the pattern of the notch grooves Va.

To set notch positions of the first sheet in the sheet bundle Sa, the numerals are selected out of the numerals 1 through 20 denoting the notch positions on the operation section 9 as shown in FIG. 18a, whereby the notch positions are determined (the portion affixed with numerals 1 through 20 corresponds to the edge of the sheet S where a notch V is formed). In FIG. 18a, the 1st, 6th, 12th, and 18th positions are determined as the notch positions. Then to set the notch positions for the 2nd and 3rd sheets in the sheet bundle Sa, the numerals are selected out of the numerals 1 through 20 denoting notch positions in the operation section 9, whereby the notch positions are determined (FIG. 18b and FIG. 18c).

The pattern of the notch grooves Va is determined by setting the notch positions corresponding to the number of the sheets in the sheet bundle Sa. Notch grooves Va are formed on the spine of the sheet bundle Sa in the bookbinding apparatus B according to the pattern having been inputted. Thus, a booklet can be bound with the pattern of the notch grooves Va meeting the user's requirements. The pattern of the notch grooves Va having been inputted through the operation section 9 is stored in the memory section 102 of the image forming apparatus A. After that, the inputted pattern can be selected.

It should be noted that the present invention is not restricted to the present embodiments. The present invention includes appropriate modifications or additions, without departing from the technological spirit of the invention claimed.

In the present embodiment, an appropriate pattern is selected out of a plurality of patterns of notch grooves Va in the image forming apparatus A. It is also possible to make such arrangements that the traveling distance “t” of the notch V (FIG. 13c) in the selected pattern can be set.

In the present embodiment, the operation of selecting the pattern of the notch grooves Va is performed according to a predetermined program by the main control section 100 of the image forming apparatus A. However, this operation can be performed by the post-processing control section 200 of the bookbinding apparatus B according to a predetermined program.

In the arrangement of FIG. 12, notch forming sections 300A, 300B, 300C, and 300D are moved with respect to the sheets S by the moving section 400. However, the position of the notches V can be changed by moving the sheets S with respect to notch forming sections 300A, 300B, 300C, and 300D.

The notch forming sections 300A, 300B, 300C, and 300D of FIG. 12 are separate from one another. However, they can be integrated into one piece, and a plurality of punches can be installed on one notch forming section.

In the bookbinding system of FIG. 1, the image forming apparatus A and bookbinding apparatus B are separate from each other. However, they can be integrated into one apparatus.

Further, the notching section 300 and moving section can be installed on a post-processing apparatus that is separately provided in addition to the image forming apparatus A and bookbinding apparatus B.

What is claimed is:

1. A notch forming device comprising:
a notch forming section for forming a notch on an edge of a sheet which constitutes a sheet bundle to be outputted by execution of a job;
a moving section for changing a position of the notch on the sheet formed by the notch forming section; and
a control section for controlling at least the moving section so as to form, on an edge of the sheet bundle, a notch groove which is composed of the notch and which has a pattern that is different according to setting content of the job to be executed.

2. The notch forming device of claim 1,
wherein the setting content relates to at least one of a type of the sheet, a basis weight of the sheet, a number of sheets constituting the sheet bundle and a thickness of the sheet bundle.

3. The notch forming device of claim 1,
wherein the setting content relates to a pattern of the notch groove selected by a user.

4. A bookbinding apparatus comprising:
the notch forming device of claim 1; and
a bookbinding section for producing a booklet by stacking the sheet on which the notch is formed by the notch forming device so as to form a sheet bundle and by gluing, using adhesive, a side of the edge of the sheet where the notch has been formed.

5. The bookbinding apparatus of claim 4,
wherein the setting content relates to at least one of a type of the sheet, a basis weight of the sheet, a number of sheets constituting the sheet bundle and a thickness of the sheet bundle.

6. The bookbinding apparatus of claim 4,
wherein the setting content relates to a pattern of the notch groove selected by a user.

7. A bookbinding system comprising:
an image forming apparatus which forms an image on a sheet; and
the bookbinding apparatus of claim 4 for bookbinding by using the sheet on which an image has been formed by the image forming apparatus,
wherein the image forming apparatus comprises an operation section through which the setting content is inputted.

8. The bookbinding system of claim 7, further comprising:
a memory section for storing a plurality of patterns of the notch groove,
wherein the bookbinding system displays, on the operation section, the plurality of patterns of the notch groove stored in the memory section so that a pattern of the notch groove can be selected among the plurality of patterns.

9. The bookbinding system of claim 8,
wherein the memory section stores a pattern of the notch groove inputted by a user through the operation section.
